(19) United States
(12) Patent Application Publication
(10) Pub. No.: US 2020/0344066 A1
(43) Pub. Date: Oct. 29, 2020

(54) INFORMATION PROCESSING APPARATUS AND DATA VERIFICATION METHOD

(71) Applicant: CANON KABUSHIKI KAISHA, Tokyo (JP)

(72) Inventor: Yoshihisa Nomura, Kashiwa-shi (JP)

(21) Appl. No.: 16/847,401

(22) Filed: Apr. 13, 2020

(30) Foreign Application Priority Data
Apr. 26, 2019 (JP) 2019-086270

(51) Int. Cl. H04L 9/32; H04L 9/30

(52) U.S. Cl. CPC H04L 9/3247; H04L 9/30

(57) ABSTRACT

An information processing apparatus includes a memory configured to store a head address of a program in a fixed address and to store the program from the head address, a first processor configured to read out, when the first processor is released from a reset state, the head address of the program by referring to the fixed address of the memory, and to read out the program from the read head address and execute the program, and a second processor configured to verify the program stored in the memory and the head address stored in the fixed address of the memory.

### BACKGROUND OF THE INVENTION

### Field of the Invention

The present disclosure relates to an information processing apparatus and a data verification method.

### Description of the Related Art

A computer attack by exploiting the vulnerability of a computer system and tampering with software operating on a computer to abuse the computer has been an issue.

International Publication No. WO 09/013825 discusses an information processing apparatus that includes a first central processing unit (CPU), a second CPU, and a nonvolatile memory storing a program to be executed by the second CPU. In the information processing apparatus, the first CPU reads out the program to be executed by the second CPU from the nonvolatile memory, verifies presence/absence of alteration of the program, and outputs the program to the second CPU depending on a result of the verification. Since the second CPU executes the program not altered, improvement in security is ensured.

The CPU starts operation when a reset state is released. When the reset state is released, the CPU refers to a specific address. In the specific address, an address where a boot program is stored is described. The CPU having referred to the specific address further refers to an address described in the specific address, and executes a boot program stored in the address.

According to International Publication No. WO 09/013825, a system that reads out the program to be executed by the CPU from an external memory and verifies presence/absence of alteration verifies the program. However, the system does not verify whether the address described in the specific address is correct. Accordingly, if the address described in the specific address is not correct, a program different from the program to be originally executed is executed.

### SUMMARY OF THE INVENTION

According to an aspect of the present disclosure, information processing apparatus includes a memory configured to store a head address of a program in a fixed address and to store the program from the head address, a first processor configured to read out, when the first processor is released from a reset state, the head address of the program by referring to the fixed address of the memory, and to read out the program from the read head address and execute the program, and a second processor configured to verify the program stored in the memory and the head address stored in the fixed address of the memory.

Further features of the present disclosure will become apparent from the following description of exemplary embodiments with reference to the attached drawings.

### BRIEF DESCRIPTION OF THE DRAWINGS

FIG. 1 is a hardware configuration diagram of a multifunctional peripheral according to an exemplary embodiment.

FIG. 2 is a software configuration diagram of the multifunctional peripheral.

FIGS. 3A and 3B are schematic views each illustrating operation in activation.

FIG. 4 is a flowchart of an activation sequence executed by a central processing unit (CPU).

FIG. 5 is a flowchart of an activation sequence executed by a CPU.

FIGS. 6A, 6B, and 6C are diagrams each illustrating a configuration of a flash memory.

### DESCRIPTION OF THE EMBODIMENTS

An exemplary embodiment of the present disclosure is described in detail below with reference to accompanying drawings. The present disclosure is not limited to the following exemplary embodiment, and all of combinations of features described in the present exemplary embodiment are not necessarily essential for solving means of the present disclosure. A multifunctional peripheral (digital multifunctional peripheral or MFP) is described as an example of an information processing apparatus that executes a data verification method according to the exemplary embodiment. An application range, however, is not limited to the multifunctional peripheral, and any other information processing apparatus may be used.

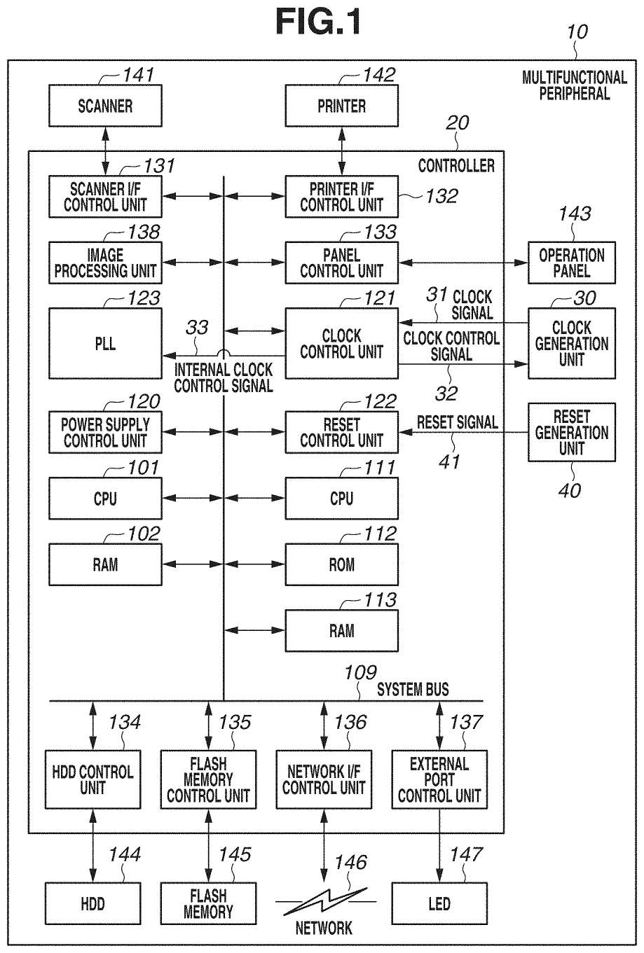

FIG. 1 is a block diagram illustrating a hardware configuration of a multifunctional peripheral 10 according to an exemplary embodiment.

A controller 20 includes hardware modules 101 to 137 described below for control of the multifunctional peripheral 10. In the present exemplary embodiment, the controller 20 is configured as a semiconductor chip.

A clock generation unit 30 generates a clock and supplies a clock signal (external clock) of a frequency suitable for each of the modules inside the multifunctional peripheral 10. In the present exemplary embodiment, the clock generation unit 30 supplies a clock signal 31 to a phase locked loop (PLL) 123 inside the controller 20. The frequency is changeable by a clock control signal 32.

A reset generation unit 40 is a semiconductor chip that generates a reset signal to reset or release the reset state of each of the modules inside the multifunctional peripheral 10. While, in the present exemplary embodiment, only a reset signal 41 that is supplied to the controller 20 is illustrated, the reset generation unit 40 is also connected to the other modules such as a scanner 141 and a printer 142. When a power is supplied to the multifunctional peripheral 10, a reset state of the reset signal 41 is maintained for a prescribed time (e.g., until supplied power voltage becomes stable), and the reset signal 41 is then set to a released state to release the reset state of the controller 20. A state where the reset signal 41 is asserted corresponds to the reset state of the reset signal 41, and a state where the reset signal 41 is deasserted corresponds to the released state of the reset signal 41. When the reset state of the controller 20 is released, the modules inside the controller 20 each start operation.

A central processing unit (CPU) 101 executes a software program of the multifunctional peripheral 10 to control the entire multifunctional peripheral 10.

A random access memory (RAM) 102 is used to store programs and to temporarily store data when the CPU 101 controls the multifunctional peripheral 10.

A hard disk drive (HDD) 144 stores a part of applications and various kinds of data. The HDD 144 stores a Java® program 214 to be executed by the CPU 101.

A flash memory 145 stores fixed parameters, etc. of the multifunctional peripheral 10. The flash memory 145 further stores a basic input/output system (BIOS) 210 to be executed by the CPU 101. The flash memory 145 further stores a loader 211, a kernel 212, and a Native program 213 to be executed by the CPU 101. The HDD 144 and the flash memory 145 may be the same storage module.

A CPU 111 executes an alteration detection software program that detects alteration of a software program to be executed by the CPU 101, and performs a part of the control in the multifunctional peripheral 10.

A read-only memory (ROM) 112 stores the alteration detection software program, a public key described below, and the like. The ROM 112 further stores a boot program 209 to be executed by the CPU 111.

The ROM 112 includes a mask ROM that includes a logic circuit not to be rewritten via an external I/F, or a one-time programmable (OTP) ROM that is writable once during manufacture.

A RAM 113 is used to store programs and to temporarily store data when the CPU 111 controls the multifunctional peripheral 10. The RAM 102 and the RAM 113 may be the same module.

A power supply control unit 120 is an integrated circuit (IC) that controls power supply to each of the modules inside the controller 20. The power supply control unit 120 can supply predetermined power to each of the modules or can stop power supply at activation and during operation of the controller 20 (multifunctional peripheral 10).

A clock control unit 121 controls the PLL 123 by an internal clock control signal 33. As a result, the PLL 123 multiplies the frequency of the clock signal 31, and supplies the clock signal having the multiplied frequency to each of the modules inside the controller 20. The clock control unit 121 controls the PLL 123 to supply a clock (internal clock) having an optimum frequency to each of the modules by changing multiplication setting of the PLL 123 at activation and during operation of the controller 20. Further, the clock control unit 121 can gate and stop the clock for each of the modules.

A reset control unit 122 controls a reset state of each of the modules inside the controller 20. The reset control unit 122 performs control to put each of the modules into a reset state or to release each of the modules from the reset state at activation and during operation of the controller 20.

A scanner interface (I/F) control unit 131 controls document reading by the scanner 141. A printer I/F control unit 132 controls print processing, etc. by the printer 142. A panel control unit 133 controls a touch panel type operation panel 143, and controls display of various kinds of information and instruction input from a user.

An HDD control unit 134 controls reading/writing of data from/to the HDD 144. For example, the HDD control unit 134 can write and store image data stored in the RAM 102, in the HDD 144 via a system bus 109.

A flash memory control unit 135 controls reading/writing of data from/to the flash memory 145. The flash memory control unit 135 reads out a program stored in the flash memory 145 to develop the program to the RAM 133 via the system bus 109 at activation of the controller 20.

A network I/F control unit 136 controls data transmission/reception with the other devices and servers on a network 146.

An external port control unit 137 is a control unit for input/output ports of the controller 20. For example, the external port control unit 137 controls the output port to turn on a light-emitting diode (LED) 147 as necessary, to notify abnormality of software or hardware to the outside.

An image processing unit 138 is a processing unit that performs shading correction on image data read by the scanner 141, or performs halftone processing and smoothing processing to output an image to the printer 142.

The system bus 109 mutually connects the modules connected to the system bus 109. Control signals from the CPU 101 and the CPU 111 and data signals between the devices are transmitted and received via the system bus 109.

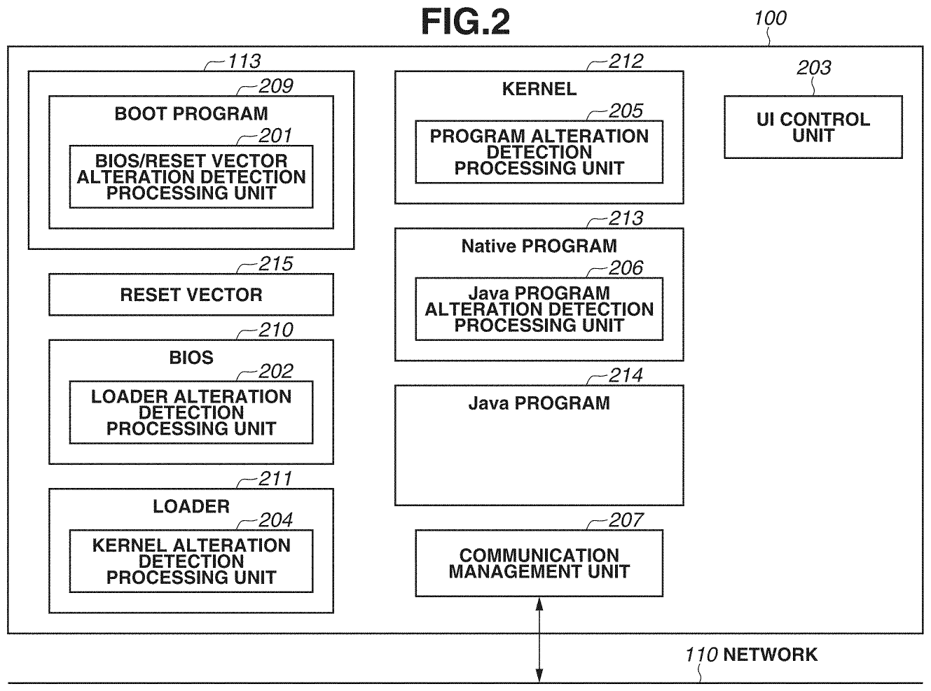

FIG. 2 is a block diagram illustrating software modules included in the multifunctional peripheral 10 according to the present exemplary embodiment. According to the present exemplary embodiment, the software is executed by the CPU 101 or the CPU 111.

A communication management unit 207 controls the network I/F control unit 136 connected to the network 146, to perform data transmission/reception with the outside via the network 146.

A user interface (UI) control unit 203 receives input to the operation panel 143 via the panel control unit 133, and performs processing corresponding to the input and screen output to the operation panel 143.

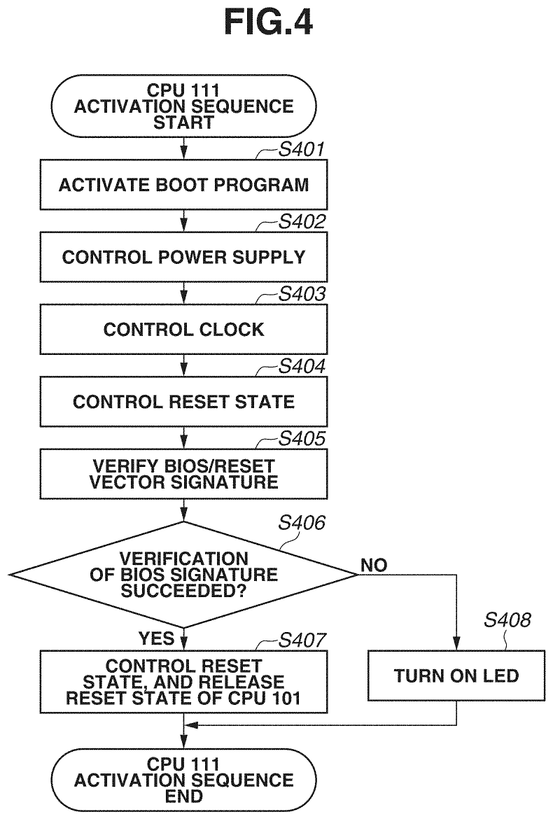

The boot program 209 is executed by the CPU 111 when the multifunctional peripheral 10 is turned on, and performs an activation sequence on the controller 20 as processing relating to the activation. The activation sequence is described below with reference to FIG. 4. The boot program 209 includes a BIOS/reset vector alteration detection processing unit 201 that detects alteration of the BIOS and a reset vector after the activation.

The BIOS 210 is executed by the CPU 101 after execution of the boot program 209. The BIOS 210 performs the processing relating to the activation, and includes a loader alteration detection processing unit 202 that detects alteration of the loader 211.

The loader 211 is executed by the CPU 101 after the processing of the BIOS 210 ends. The loader 211 performs the processing relating to the activation, and includes a kernel alteration detection processing unit 204 that detects alteration of the kernel 212.

The kernel 212 is executed by the CPU 101 after the processing of the loader 211 ends. The kernel 212 performs the processing relating to the activation, and includes a program alteration detection processing unit 205 that detects alteration of the Native program 213.

A reset vector 215 is an address that is first referred (accessed) by the CPU 101 released from the reset state. In the address, a head address of a program to be executed next is described. The CPU 101 released from the reset state refers to the reset vector, reads out the address described in the reset vector (i.e., head address of program), reads out the program from the readout head address, and executes the program. Depending on the CPU, a method in which an instruction is described in the reset vector and the instruction is executed to access a specific address may be used. In the present exemplary embodiment, the former method is described.

The Native program 213 is executed by the CPU 101, and includes a plurality of programs that provides functions in cooperation with the Java® program 214 of the multifunctional peripheral 10. The plurality of programs includes, for example, programs to control the scanner I/F control unit 131 and the printer I/F control unit 132, the activation program, and a reactivation program of the CPU 111. The activation program and the reactivation program of the CPU 111 are called from the Native program 213 by the kernel 212 to perform activation processing. To use the CPU 111 that has executed the boot program and completed the BIOS/reset vector alteration detection processing, for the other purpose different from the alteration detection processing, the reactivation program of the CPU 111 causes the CPU 111 to execute a program corresponding to the other purpose. For example, the CPU 101 executes the reactivation program of the CPU 111 such that a monitoring program for monitoring interruption of the external port in a power saving mode is executed by the CPU 111 having completed the alteration detection processing. The power saving mode indicates a state where supply of the power or the clock to the control units and the processing units other than the CPU 111, the external port control unit 137, the system bus 109, the network I/F control unit 136, and the operation panel 143 is safely stopped from the normal operating state. When the CPU 111 detects interruption of the external port from the external port control unit 137 due to input of a signal from, for example, a sensor, the CPU 111 performs processing to return the operation mode from the power saving mode to the normal mode. The CPU 111 safely shifts the control units and the processing units to which supply of the power or the clock has been stopped, into the operating state. In a case where the CPU 111 has a small scale and consumes small standby power as compared with the CPU 101, monitoring of interruption by the CPU 111 allows for supply stoppage of the power or the clock of the CPU 101 performing the processing in the normal operation, which makes it possible to improve a power saving effect. Further, the Native program 213 includes a Java® program alteration detection processing unit 206 that detects alteration of the Java® program, as one of the programs.

The Java® program 214 is a program executed by the CPU 101, and provides functions in cooperation with the Native program 213 of the multifunctional peripheral 10 (e.g., program to display screen on operation panel 143).

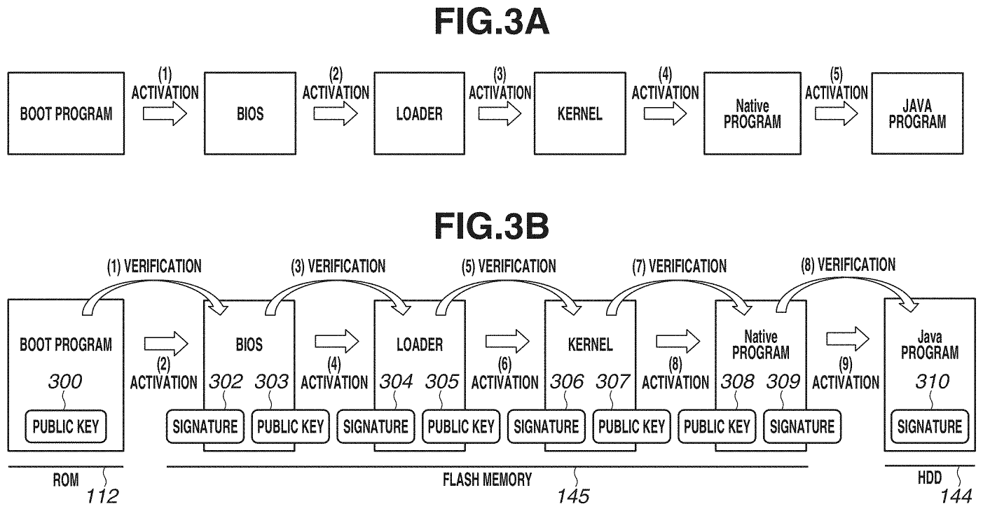

Next, the activation sequence of the multifunctional peripheral 10 is described with reference to FIGS. 3A and 3B.

FIG. 3A is an activation sequence diagram schematically illustrating an activation order of the multifunctional peripheral 10 without alteration detection. The boot program 209 activates the BIOS 210, the BIOS 210 activates the loader 211, the loader 211 activates the kernel 212, and the kernel 212 activates the activation program in the Native program 213. The Java® program 214 is activated in the activation program. Then, the Native program 213 and the Java® program 214 cooperate with each other to provide the functions of the multifunctional peripheral 10.

FIG. 3B illustrates the activation sequence of the processing in which the BIOS 210, the reset vector 215, the loader 211, the kernel 212, the Native program 213, and the Java® program 214 are activated sequentially from the boot program 209 while performing the alteration detection. Further, FIG. 3B also schematically illustrates storage locations of the programs and storage locations of digital signatures (hereinafter, referred to as signatures) and public keys.

Each of the signatures is obtained by converting, for example, a genuine program (data string) into a hash value by a predetermined hash function and encrypting the hash value using a private key corresponding to the public key. The encrypted hash value is decrypted by the public key to calculate the hash value of the genuine program, and the program as an alteration verification target is converted into the hash value by the above-described hash function. The two hash values are then compared. When the two hash values are equal to each other, it is determined that the program as the verification target has not been altered from the genuine program. If the two hash values are different from each other, it is determined that the program as the verification target has been altered from the genuine program. The method to determine presence/absence of alteration of the program as the verification target using the signature is hereinafter referred to as signature verification. Further, a result indicating that the program has not been altered is referred to as success in signature verification, and a result indicating that the program has been altered is referred to as failure in signature verification. While, in the present exemplary embodiment, as the method to determine presence/absence of alteration of the program, such a method using the signature and the public key is adopted, the other method to determine presence/absence of alteration may be adopted.

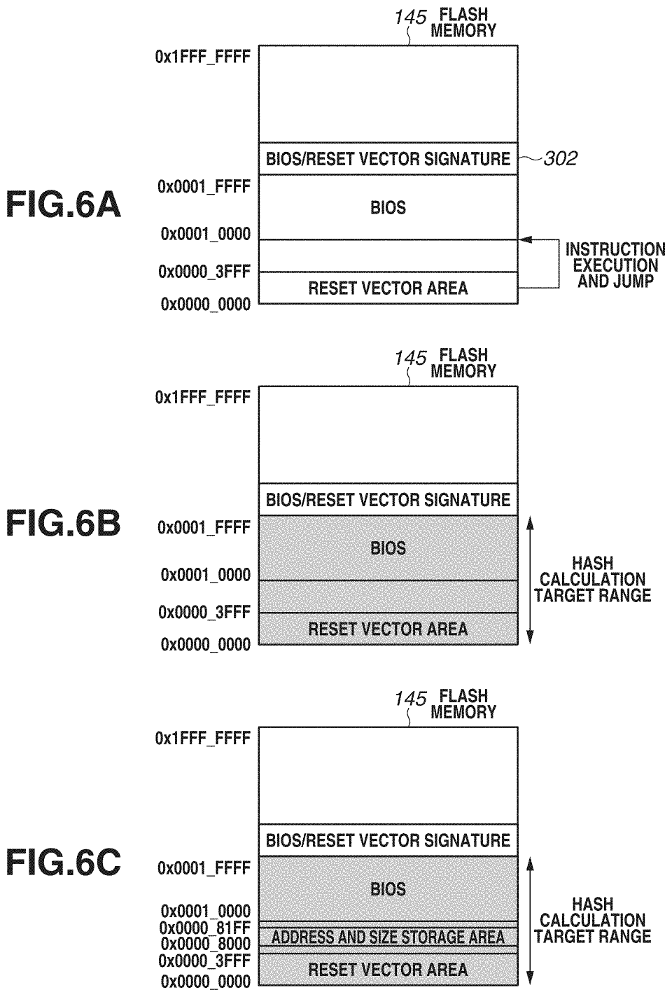

FIG. 6A is a configuration diagram of the flash memory 145. In the present exemplary embodiment, description will be given of a case where addresses 0x0000_0000 (block number) to 0x0001_FFFF (block number) in a predetermined range where at least the BIOS 210 and the reset vector 215 are stored are regarded as one hash calculation target range, and a size of the range is previously fixed. The address range at least includes consecutive addresses from an address (0-th address) where the reset vector 215 is stored to an end address where the BIOS 210 is stored. Further, in the address range, data strings other than the reset vector 215 and the BIOS 210 are also stored. Collecting the hash calculation targets to one range having the fixed size can simplify the processing of the boot program 209. Meanwhile, when the reset vector 215 and the BIOS 210 are disposed at positions separated from each other, extra hash calculation of data strings is necessary, and a restriction in creation size of the BIOS 210 is imposed. The reset vector 215 of the CPU 101 is set in addresses 0x0000000 to 0x000_3FFFF of the flash memory 145. As described above, when the reset state of the CPU 101 is released, the CPU 101 refers to the address 0x0000_0000. Depending on the system, the reset vector 215 of the CPU 101 may be disposed in the address 0xFFFF_0000. In the reset vector area, an exception handler (reset handler) and an address (head address of program) of interruption service routine (ISR) are described. The CPU 101 released from the reset state refers to the reset vector area, and can execute the program from the address described in the reset vector. In FIG. 6A, a jump destination address is set to an address 0x00010000. The CPU 101 released from the reset state executes an instruction to jump to the jump destination address based on the reset handler. The CPU 101 then executes the BIOS 210 stored in the addresses x00010000 to 0x0001_FFFF.

FIG. 6B is a configuration diagram of a BIOS/reset vector signature 302 on the flash memory 145. The BIOS/reset vector signature 302 is obtained by encrypting the hash value of the data string stored in consecutive memory areas (addresses) from an area of the reset vector area 215 to an area of the BIOS 210, using the private key corresponding to the public key. In other words, the hash value of the data string that includes the BIOS 210 and the reset vector 215 where the head address of the BIOS 210 is described is stored as the BIOS/reset vector signature 302 in the flash memory 145, in a state of being encrypted using the private key. The CPU 111 decrypts, using the public key, the hash value encrypted using the private key to acquire the hash value of the genuine program (BIOS 210) and the genuine address (head address of BIOS 210) to be described in the reset vector 215. Further, the CPU 111 calculates the hash value of the data string that includes the program (BIOS 210) as the alteration verification target currently stored in the flash memory 145 and the address currently described in the reset vector 215. Then, the CPU 111 compares these two hash values. The BIOS 210 and the address described in the reset vector 215 are verified by the CPU 111 in the above-described manner.

For example as illustrated in FIG. 6C, in the present exemplary embodiment, the head addresses and the sizes of the reset vector and the BIOS are stored in vacant addresses 0x0000_8000 to 0x0000_81FF between the reset vector area and the BIOS in the hash calculation target range. The CPU 111 may read the head addresses and the sizes in the boot program 209 to convert the data string in a necessary area into a hash value.

The boot program 209 includes a BIOS/reset vector verification public key 300, the BIOS 210 includes the BIOS/reset vector signature 302 and a loader verification public key 303, and the loader 211 includes a loader signature 304 and a kernel verification public key 305. The kernel 212 includes a kernel signature 306 and a Native program verification public key 307, and the Native program 213 includes a verification public key 308 for both of the Native program 213 and the Java® program 214 and Native program signature 309. The Java® program 214 includes a Java® program signature 310. These public keys and signatures are previously provided to the programs before shipment of the multifunctional peripheral 10.

Each of the alteration detection processing units 201, 202, and 204 to 206 verifies whether the corresponding next program has been altered. When the corresponding next program has not been altered, each of the alteration detection processing units 201, 202, and 204 to 206 activates the corresponding next program. As described above, the multifunctional peripheral 10 is activated based on the activation sequence in which the program alteration detection and the activation are sequentially performed.

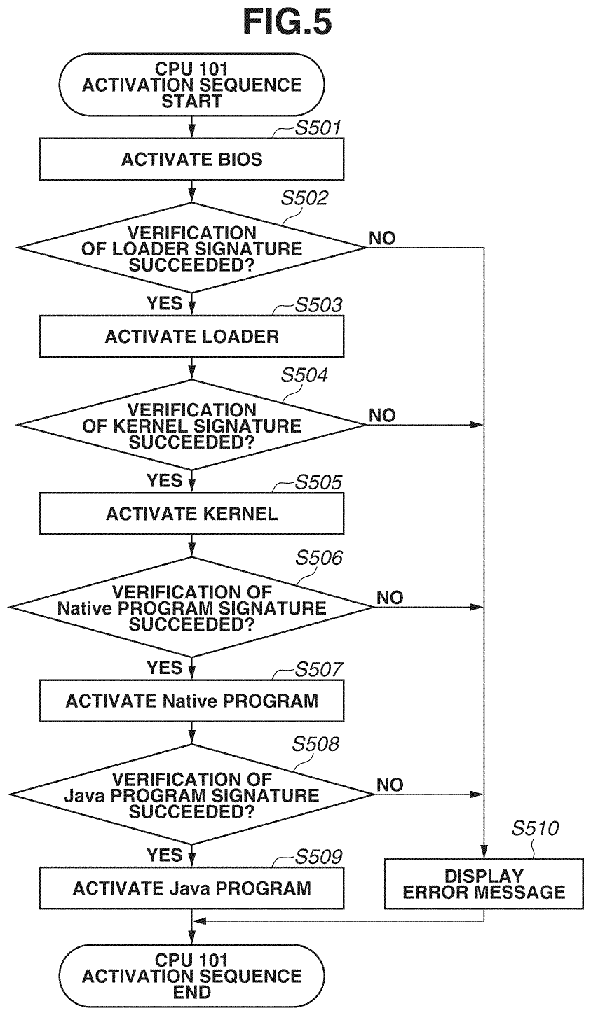

A method in which the alteration detection program safely activates the CPU 101 in the above-described activation sequence that is a feature of the present exemplary embodiment is described with reference to FIG. 4 and FIG. 5.

FIG. 4 is a flowchart of the processing of the activation sequence performed by the CPU 111, and FIG. 5 is a flowchart of the processing of the activation sequence performed by the CPU 101.

In an initial state of the present exemplary embodiment, the processing in the flowchart of FIG. 4 is performed after operation with the following setting is performed.

When the multifunctional peripheral 10 is turned on, the power supply control unit 120 performs control to supply power to the units of the controller 20.

When the power is supplied to the clock control unit 121, the clock control unit 121 controls an oscillator or a vibrator of the clock generation unit 30 to generate the clock signal 31 by outputting the clock control signal 32 to the clock generation unit 30. Further, the clock control unit 121 controls the PLL 123 to generate a desired internal clock of the controller 20 by outputting the internal clock control signal 33 to the PLL 123.

Next, the reset generation unit 40 releases the reset state of the reset control unit 122 via the reset signal 41.

When the reset state of the reset control unit 122 is released, the reset control unit 122 first releases the reset state of each of the system bus 109, the ROM 112, the CPU 111, the flash memory control unit 135, and the flash memory 145. In this processing, the CPU 101 is still in the reset state. The reset vector of the CPU 111 holds the address of the ROM 112. In other words, when the reset state of the CPU 111 is released, the CPU 111 executes the program stored in the ROM 112. The reset vector of the CPU 101 holds the address of the flash memory 145. When the reset state of the CPU 101 is released, the CPU 101 reads the reset vector. The CPU 101 accesses the address described in the reset vector, and executes the BIOS program stored in the flash memory 145.

The activation sequence performed by the CPU 111 is described below along steps S401 to S408 in FIG. 4. The following processing is performed by the software modules illustrated in FIG. 2 executed by the CPU 111. The activation sequence is characterized by processing in step S405. More specifically, the signature of the program (BIOS 210) and the reset vector where the head address of the program is to be described is verified in determination processing to determine presence/absence of program alteration (processing is hereinafter referred to as alteration detection processing).

In step S401, when the reset state of the CPU 111 is released, the CPU 111 first executes the boot program stored in the ROM 112.

In step S402, the CPU 111 performs power supply control based on the boot program. In this processing, the CPU 111 performs control to supply power only to a part of the modules inside the controller 20 necessary for alteration detection. In the present exemplary embodiment, the power is supplied to at least the following modules necessary for the alteration detection processing. The power is supplied to the clock control unit 121, the reset control unit 122, the PLL 123, the power supply control unit 120, the CPU 101, the flash memory 145, and the RAM 102. In addition, the power is supplied to the CPU 111, the ROM 112, the RAM 113, the HDD control unit 134, the flash memory control unit 135, and the external port control unit 137.

In step S403, the CPU 111 performs the following clock control based on the boot program. An operation frequency of each of the modules inside the controller 20 after activation of the controller 20 is completed is varied depending on a product specification. The clock control unit 121 instructs, by the clock control signal 32, the clock generation unit 30 to supply the desired clock signal 31. When the external clock is changed, it is necessary to wait a prescribed time until a crystal resonator or a crystal oscillator becomes stable.

The clock control unit 121 controls, by the internal clock control signal 33, the PLL 123 to set a frequency of the internal clock to be supplied to the necessary modules inside the controller 20, to a desired frequency. This enables execution of the processing of the CPU 111, the system bus 109, and the flash memory control unit 135.

The clock control unit 121 performs the following processing to change the frequency of the internal clock. The clock control unit 121 gates the clock from the PLL 123 once to switch the clock to the external clock bypassing the PLL 123. Then, the clock control unit 121 supplies the desired internal clock to each of the modules after the internal clock generated by the PLL 123 becomes stable. In this processing, the control to switch the internal clock also stops supply of the clock to the CPU 111. Therefore, a hard sequencer is provided inside the clock control unit 121.

The clock control unit 121 sets the frequency of the clock to be supplied to each of the CPU 101, the flash memory 145, the RAM 102, the CPU 111, the ROM 112, the RAM 113, the system bus 109, the HDD control unit 134, and the flash memory control unit 135, to the desired frequency. The frequency of the clock to be supplied may be changed depending on the supply destination module.

In step S404, the CPU 111 releases the reset state based on the boot program. In other words, the CPU 111 releases the reset state of each of the modules necessary for the alteration detection processing. More specifically, the reset state of each of the RAM 113, the system bus 109, and the HDD control unit 134 is released.

In step S405, the CPU 111 verifies the BIOS and reset vector signature based on the boot program. The BIOS/reset vector alteration detection processing unit 201 included in the boot program 209 reads the BIOS 210 and the address described in the reset vector 215 from the flash memory 145 to the RAM 113 via the system bus 109. In the present exemplary embodiment, fixed areas of the fixed addresses 0x0000_0000 to 0x0001_FFFF are read as illustrated in FIG. 6B. Next, the BIOS/reset vector alteration detection processing unit 201 verifies the BIOS/reset vector signature 302 using the BIOS/reset vector verification public key 300. While, in the present exemplary embodiment, the BIOS 210 and the address described in the reset vector 215 are collectively verified, the BIOS 210 and the address described in the reset vector 215 may be separately verified. Further, the addresses and the sizes of the reset vector and the BIOS may not be fixed. In this case, the head addresses and the sizes of the reset vector and the BIOS are stored in the hash calculation target range and are read as described above.

In step S406, the CPU 111 determines whether the verification of the BIOS/reset vector signature has succeeded. In a case where the BIOS and the reset vector are genuine (true) and have not been altered (hash value and signature value are coincident with each other) as a result of the signature verification, it is determined that the signature verification has succeeded (YES in step S406), and the processing proceeds to step S407. In a case where the contents of the BIOS or the reset vector have been altered (hash value and signature value are not coincident with each other), it is determined that the signature verification has failed (NO in step S406), and the processing proceeds to error processing in step S408. In other words, in the present exemplary embodiment, even in a case where the reset vector has been altered, the processing proceeds to the error processing in step S408.

In step S407, the CPU 111 controls the reset control unit 122 to release the reset state of each of the CPU 101, the flash memory 145, and the RAM 102, and terminates the processing of the boot program. The processing of the activation sequence proceeds to step S501 described below. In other words, the CPU 101 executes and activates the BIOS 210.

In step S408, to notify failure of the signature verification in step S406, the BIOS/reset vector alteration detection processing unit 201 (CPU 111) controls the external port control unit 137 to turn on the LED 147, and terminates the processing of the boot program.

The CPU 101 can execute the BIOS 210 via the reset vector not altered, by performing the above-described sequence.

The activation sequence performed by the CPU 101 is described below along steps S501 to S510 in FIG. 5. The following processing is performed by the software modules illustrated in FIG. 2 executed by the CPU 101. In the processing described below, a method of determining presence/absence of alteration of the program (loader 211, kernel 212, Native program 213, and Java® program) is illustrative. The other method may be executed as long as the method can detect alteration of the program.

In step S501, the reset state of the CPU 101 is released, and the CPU 101 refers to (accesses) the reset vector. In the present exemplary embodiment, the reset vector is designed to be located in the flash memory 145. Therefore, the CPU 101 released from the reset state refers to the reset vector via the system bus 109, and reads out the address (head address of BIOS 210) described in the reset vector. The CPU 101 jumps to the readout address (head address of BIOS 210), reads the BIOS 210 from the flash memory 145, and executes the BIOS 210. When the BIOS 210 is activated, the BIOS 210 performs various kinds of initialization processing, and the loader alteration detection processing unit 202 included in the BIOS 210 reads the loader 211, the kernel verification public key 305, and the loader signature 304 from the flash memory 145 to the RAM 102. In the initialization sequence, for example, the HDD control unit 134 is initialized to enable the HDD 144 to be accessed.

In step S502, the loader alteration detection processing unit 202 verifies the loader signature 304 using the loader verification public key 305, and determines whether the signature verification has succeeded. In a case where the signature verification has failed (NO in step S502), the loader alteration detection processing unit 202 initializes the panel control unit 133 and displays an error message on the operation panel 143 in step S510. The processing then ends. In a case where the signature verification has succeeded (YES in step S502), the loader alteration detection processing unit 202 terminates the processing, and the BIOS 210 activates the loader 211 read in the RAM 102.

In step S503, the loader 211 is activated and performs various kinds of initialization processing. In the initialization in this processing, for example, the panel control unit 133 is initialized to display an activation screen on the operation panel 143. Further, the kernel alteration detection processing unit 204 included in the loader 211 reads the kernel 212, the Native program verification public key 307, and the kernel signature 306 from the flash memory 145 to the RAM 102.

In step S504, the kernel alteration detection processing unit 204 verifies the kernel signature 306 using the kernel verification public key 305, and determines whether the signature verification has succeeded. In a case where the signature verification has failed (NO in step S504), the kernel alteration detection processing unit 204 displays an error message on the operation panel 143 in step S510. The processing then ends. In a case where the signature verification has succeeded (YES in step S504), the kernel alteration detection processing unit 204 terminates the processing, and the loader 211 activates the kernel 212 read in the RAM 102.

In step S505, the kernel 212 is activated and performs various kinds of initialization processing. In the initialization in this processing, for example, the network I/F control unit 136 is initialized to enable communication with the network 146. Next, the program alteration detection processing unit 205 reads the verification public key 308 for both of the Native program 213 and the Java® program 214, and the Native program signature 309 from the flash memory 145 to the RAM 102.

In step S506, the program alteration detection processing unit 205 verifies the Native program signature 309 using the verification public key 308, and determines whether the signature verification has succeeded. In a case where the signature verification has failed (NO in step S506), the program alteration detection processing unit 205 displays an error message on the operation panel 143 in step S510. The processing then ends. In a case where the signature verification has succeeded (YES in step S506), the program alteration detection processing unit 205 terminates the processing, and the Native program 213 is activated.

In step S507, the Java® program alteration detection processing unit 206 that performs the alteration detection processing is activated from the Native program 213, the Java® program alteration detection processing unit 206 reads the Java® program 214 and the Java® program signature 310 from the HDD 144 to the RAM 102. Further, the Java® program alteration detection processing unit 206 executes activation programs to activate the scanner 141 and the printer 142. The Native program 213 changes the program activation unit of the CPU 111 from the ROM 112 to the RAM 113 (i.e., changes activation mode of CPU 111 from ROM boot to RAM boot) based on the reactivation program of the CPU 111. Then, the Native program 213 writes the above-described monitoring program in the RAM 113 and resets the CPU 111 once to release the reset state of the CPU 111, based on the reactivation program. As a result of the processing, the CPU 111 is reactivated. The CPU 111 performs RAM booting and executes the monitoring program by the reactivation, unlike the processing in step S401.

In step S508, the Java® program alteration detection processing unit 206 verifies the Java® program signature 310 using the verification public key 308 read in the RAM 102 in step S505, and determines whether the signature verification has succeeded. In a case where the signature verification has failed (NO in step S508), the Java® program alteration detection processing unit 206 displays an error message on the operation panel 143 in step S510. The processing then ends. In a case where the signature verification has succeeded (YES in step S508), the Java® program alteration detection processing unit 206 terminates the processing, and the Java® program 214 is activated in step S509.

In the processing in step S510, the error message is displayed on the operation panel 143. Alternatively, as with the processing in step S410, the external port control unit 137 is controlled to turn on the LED 147. Yet alternatively, both of display of the error message on the operation panel 143 and turning-on of the LED 147 may be performed.

As described above, according to the present exemplary embodiment, the boot program performs processing to detect alteration of not only the BIOS but also the reset vector, which makes it possible to enhance security level.

While, in the present exemplary embodiment, the case where the public keys are all different from one another has been described, some public keys may be the same as one another. The storage locations of the programs other than the boot program are not limited, and the programs may be stored in other storage medium. In addition, the storage locations of the programs may not be present in the above described place. For example, the loader 211 may be stored in the flash memory 145 or the ROM 112.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2019-086270, filed Apr. 26, 2019, which is hereby incorporated by reference herein in its entirety.

What is claimed is:

1. An information processing apparatus, comprising:
a memory configured to store a head address of a program in a fixed address and to store the program from the head address;
a first processor configured to read out, when the first processor is released from a reset state, the head address of the program by referring to the fixed address of the memory, and to read out the program from the read head address and execute the program; and
a second processor configured to verify the program stored in the memory and the head address stored in the fixed address of the memory.

2. The information processing apparatus according to claim 1, wherein, in a case where it is determined by the verification that the program stored in the memory and the head address stored in the fixed address of the memory are true, the second processor releases the reset state of the first processor.

3. The information processing apparatus according to claim 1, wherein the second processor verifies the program and the head address by verifying a data string that is stored in addresses in a predetermined range of the memory where at least the program and the head address are stored.

4. The information processing apparatus according to claim 3, wherein the data string to be verified includes the program and the head address and also data that is stored in consecutive addresses from the fixed address to the head address.

5. The information processing apparatus according to claim 1, wherein the fixed address of the memory is a reset vector of the first processor.

6. The information processing apparatus according to claim 1,
wherein the memory stores a signature of the program and the head address, and
wherein the second processor includes a calculation unit configured to calculate the signature of the program and the head address stored in the memory, and performs the verification based on whether the signature read out from the memory and the calculated signature are coincident with each other.

7. The information processing apparatus according to claim 6,
wherein the memory stores the signature of the program and the head address which has been encrypted using a private key, and
wherein the second processor includes a decryption unit configured to decrypt the encrypted signature using a public key paired with the private key, and performs the verification based on whether the signature that has been read out from the memory and decrypted and the calculated signature are coincident with each other.

8. The information processing apparatus according to claim 6, wherein the signature is a hash value.

9. The information processing apparatus according to claim 1, wherein the second processor performs the verification based on a predetermined program.

10. The information processing apparatus according to claim 9, wherein after the verification based on the predetermined program, the second processor executes another program different from the predetermined program.

11. The information processing apparatus according to claim 10,
wherein, after the verification by the second processor, the first processor changes an activation mode of the second processor and resets the second processor and releases the reset state of the second processor, and
wherein, when the second processor is released from the reset state by the first processor, the second processor executes the another program based on the changed activation mode.

12. A data verification method performed by an information processing apparatus, the information processing apparatus including a memory configured to store a head address of a program in a fixed address and to store the program from the head address, and a first processor configured to read out, when the first processor is released from a reset state, the head address of the program by referring to the fixed address of the memory, and to read out the program from the read head address and execute the program, the method comprising:
verifying the program stored in the memory and the head address stored in the fixed address of the memory.

13. The data verification method according to claim 12, further comprising:
releasing the reset state of the first processor in a case where it is determined by the verification that the program stored in the memory and the head address stored in the fixed address of the memory are true.

14. The data verification method according to claim 12, wherein the program and the head address are verified by verification of a data string that is stored in addresses in a predetermined range of the memory where at least the program and the head address are stored.

15. The data verification method according to claim 14, wherein the data string to be verified includes the program and the head address and also data that is stored in consecutive addresses from the fixed address to the head address.

16. The data verification method according to claim 12, wherein the fixed address of the memory is a reset vector of the first processor.
